(19) United States
(12) Patent Application Publication
(10) Pub. No.: US 2012/0265870 A1
(43) Pub. Date: Oct. 18, 2012

(54) DATA TAPS ON A SERVER-MANAGED DATA INTEGRATION PROCESS

(75) Inventors: Wenjin Zhang, Shanghai (CN); Wee Hyong Tok, Singapore (SG); Xiaoyan Zhao, Shanghai (CN); Xiaochen Wu, Shanghai (CN); Xiaoning Ding, Shanghai (CN); Stephen Tower Swartz, Snohomish, WA (US); Bekim Demiroski, Shanghai (CN)

(73) Assignee: MICROSOFT CORPORATION, Redmond, WA (US)

(21) Appl. No.: 13/088,029

(22) Filed: Apr. 15, 2011

(51) Int. Cl. G06F 15/16

(52) U.S. Cl. 709/224

(57) ABSTRACT

Analyzing data in one or more data flows of an integration package. The integration package includes one or more executable integration processes including one or more data flows that when executed on a server cause data to be integrated from a source system to a destination system according to transformations defined in the integration package. A method includes receiving a data package including a contained unit of one or more data flows. The method further includes defining a tap at a point in one of the data flows. The method further includes executing the data flow. The method further includes collecting data at the tap point flowing through the tap point as a result of executing the data flow. The method further includes storing data collected at the tap point in a specified storage location.

### BACKGROUND

### Background and Relevant Art

Computers and computing systems have affected nearly every aspect of modern living. Computers are generally involved in work, recreation, healthcare, transportation, entertainment, household management, etc.

Computing systems are often used for data processing. For example, data can be retrieved from a source, have one or more transformations applied to it, and the transformed data stored in a destination location. Illustrating a specific example, data may be stored at various locations, such as databases, files in a filesystems, etc. In one example, flat files are stored in a filesystem. A data integration process can be used to load the data from multiple flat files into a destination data warehouse. As part of the data integration process, a Lookup transformation can be used to retrieve additional information about that the data is loaded. These data are then written to the destination data warehouse.

Often data processing can be performed using integration processes provided by an integration process developer. A developer may design several data integration processes. These get encapsulated into a self-contained project file (which can contain several data integration definitions). The project file may be deployed to a server, and can be managed by the server administrator. In particular, a developer may provide project file to a system administrator, who can then run the project file on a server. This results in data being integrated from one system into another system according to one or more transformations defined in the processes.

Integration processes may be a set of one or more data flows that can be applied to a data store to access, manipulate and store data. A developer of integration services may sometimes be referred to as an ETL (for extract, transformation, and load) developer.

When data integration processes are executed on a server, the server administrator may not have the ability to intercept the data that passes through the process. This prevents the server administrator from being able to perform troubleshooting of data issues that might cause the data integration process to load incomplete or incorrect data into destination servers or files.

The subject matter claimed herein is not limited to embodiments that solve any disadvantages or that operate only in environments such as those described above. Rather, this background is only provided to illustrate one exemplary technology area where some embodiments described herein may be practiced.

One embodiment disclosed herein is directed to a method practiced in a computing environment. The method includes acts for analyzing data in one or more data flows of one or more integration packages. The integration packages include one or more executable integration processes including one or more data flows that when executed on a server cause data to be integrated from a source system to a destination system according to one or more transformations defined in the integration package. The method includes receiving a data package including a contained unit of one or more data flows. The method further includes defining a tap at a point in one of the data flows. The method further includes executing the data flow. The method further includes collecting data at the tap point flowing through the tap point as a result of executing the data flow. The method further includes storing data collected at the tap point in the specified storage location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates communication between a developer environment and a server;

FIG. 2 illustrates various data flow components;

FIG. 3A illustrates an example data flow;

FIG. 3B illustrates tap points set in the example data flow;

FIG. 3C illustrates files for storing data from the tap points in the example data flow;

FIG. 4 illustrates a method of analyzing data in one or more data flows of an integration package; and

FIG. 5 illustrates an example of a data flow having child transform components.

### DETAILED DESCRIPTION

Some embodiments herein may be implemented to allow a server administrator (who may not have deep knowledge of the internals of a data integration process) an intuitive way to intercept data at the right point within the data integration process, even without a development tool on the server on which an integration process is being run. In particular, in some embodiments, interception points may be easily described by a server administrator.

In some embodiment, the server administrator may be able to pass the data that is intercepted to a developer that has knowledge of the internals of a data integration process. The developer can then perform troubleshooting based on the data passed to the developer.

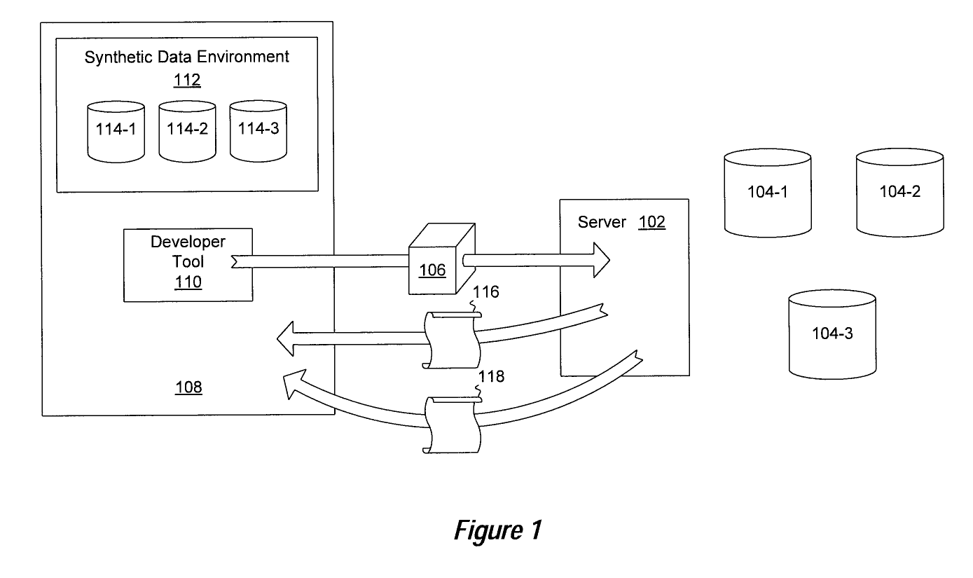

Referring now to FIG. 1, an example is illustrated. In the example illustrated in FIG. 1, the server 102 may execute various integration processes with respect to data stores 104-1, 104-2 and 104-3. The integration processes can cause data to be extracted from one of the data stores (referred to herein generally as 104, but shown specifically at 104-1, 104-2, and 104-3), transform the data, and load the data onto another data store 104 (or in some bases back to the same data store).

When an integration process is run, errors may occur. Three particular types of problems that cause errors are now described. One class of problems relates to an integration process, or package of integration processes failing. For example, a source of data or a destination for data may not respond to an integration process, which causes the process to fail completely. In another example, a data structure or schema of a data source or destination may have changed such that the integration process is no longer able to access the source or destination. In another example, other changes at the data destination may have changed preventing data from being written to the destination, thus causing the integration process to fail.

A second class of problems relates data problems. For example, there may be situations where a package or process successfully executes, but the data is incorrect. For example, a user may expect thousands of rows of data to be read, transformed, and saved, and yet after the process is executed, only a few lines of data may have been saved.

A third class of problems relates to performance issues. For example, while data may be able to be read, transformed, and saved correctly, it may happen over a longer than expected period of time, or may consume an unexpected amount of resources.

Returning once again to the example illustrated in FIG. 1, a developer may provide an integration package 106 to the server 102. In particular, in some embodiments, data integration project contains one or more packages. Each of the packages describes a data integration process. Each of the packages can include, for example, one control flow, and several data flows. In a control flow, the package can invoke other packages. The server 102 can then execute the integration package 106. The integration package 106 is shown as being delivered from a developer system 108. The developer system 108 includes a developer tool 110 which a developer is able to use to create the integration package 106. The developer system 108 also includes a synthetic data environment 112. The synthetic data environment 112 includes a number of simulated data stores (referred to herein generically as 114, but shown as specific examples at 114-1, 114-2, and 114-3). The simulated data stores 114 contain developer data, which in some embodiments may be test data. The simulated data stores 114 can be used by the developer, using the developer tool 110, to create and model the integration packages 106, and to test the packages 106 by executing them at the developer system 108. The simulated data stores 114 can be used to implement data sources and destinations used when executing the packages 106.

However, inasmuch as the simulated data stores 114 are simulated and not the actual data stores 104 that will be accessed when the integration package 106 is executed on the server 102, a developer may not be able to provide a completely error free integration package 106 that will run on the server 102, due to differences between the simulated data stores 114, and the actual data stores 104. Such differences may relate to network connectivity, data store processing power, actual data in a data store, schema of a data store, etc.

When an integration package 106 is executed at the server 102, errors, as described above, may occur. A server administrator may be able to provide information collected at the server 102 to a developer at the developer machine 108, so that the developer may assist in troubleshooting the integration package 106. Ultimately, embodiments may be implemented where data captured at some point of a data flow of the integration package 106 can be provided to the developer so that the developer can assist in trouble shooting the integration package 106.

To be able to determine a point in a data flow to implement a tap to collect captured data 118, a server administrator may need to provide other information first to the developer so that the developer can assist in setting a tap. In one embodiment, this may occur, for example, by a server administrator providing a description of the problem. In an alternative embodiment, the server 102 may be able to provide some higher level troubleshooting data from which the administrator can determine where a tap should be set.

In the example, illustrated, the server 102 is able to perform some high level troubleshooting and to generate a high level troubleshooting report 116. The high level troubleshooting report 116 may be generated as a result of a server administrator requesting that the report 116 be generated. In one alternative, the report 116 may be generated as part of an automatic logging process. Other appropriate mechanisms may be used to generate the high level report 116.

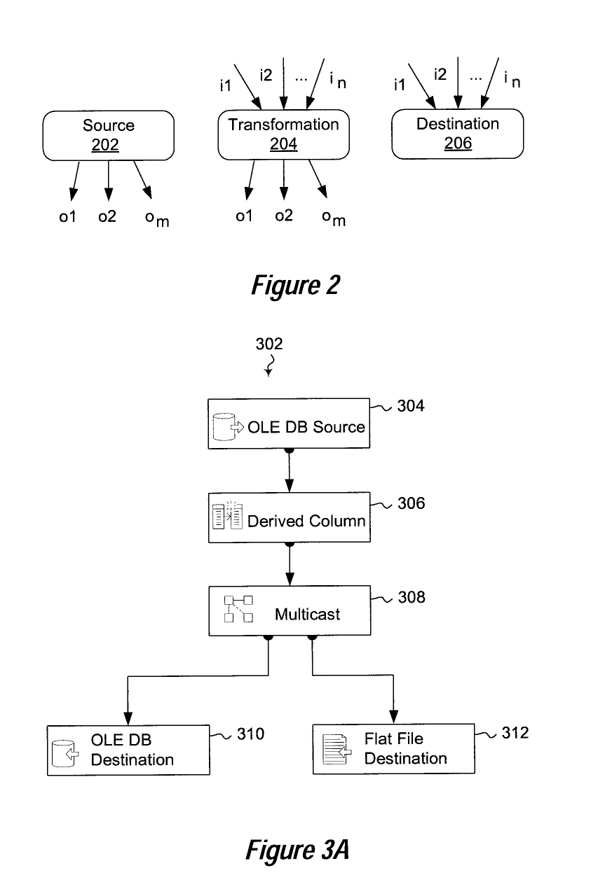

The high level report 116 may be generated based on predetermined and pre-deployed tap points or other data metric mechanisms. For example, in one embodiment, predetermined tap points may be placed at the output of a source component 202 (see FIG. 2) and/or the input of a destination component 206. This can allow a system administrator or a developer to determine generally what happens at the ends of the data flow. Alternatively, the high level report may simply quantify the amount of data passing a given point(s), such as the output of a source component and/or the input of a destination component.

The high level report 116 can be provided to the developer at the developer system 108. The developer can then provide information to an administrator at the server 102, indicating where a tap should be placed in the execution of the integration package 106 to collect the captured data 118. The captured data 118 can then be sent to the developer at the developer machine 108. The developer at the developer machine 108 can then examine the captured data 118 in a process of trouble shooting the integration package 106.

As noted above, a tap may be set to obtain the captured data 118. In some embodiments, a user may be able to declaratively define points in a data integration process from which data is to be tapped. Some embodiments may tap the data from the data integration process and write to data files or other data storage structures. In particular, some embodiments may perform data taps during execution of data integration processes.

This may allow for a server administrator to tap the data outputs of any data flow components to files. It provides the server administrator with the ability to provide these data files to an ETL developer for investigations on data-related issues.

As illustrated in FIG. 1, an ETL developer works with a subset/synthetic data as illustrated in the synthetic data environment 112 in a developer environment, such as the developer system 108. The ETL developer may not have access to the production environment in which the server 102 is operated or to the data in the data stores 104.

The developer tool 110, which in some embodiments may be Business Intelligence Development Studio available from Microsoft Corporation of Redmond Wash., is not commonly installed in production environment servers 102. Additionally, developers are generally not able to connect from the developer system 108 to a production environment server 102.

The server administrator at the server 102 generally does not understand the integration package 106 structure or internal transformations and data flow. The server administrator at the server 102 generally does not understand the different paths between components in the integration package 106.

However, using instructions from the ETL developer, the server administrator at the server 102 is able to specify one or more specific components in the integration package 106 and inputs and/or outputs where to tap data for investigation. As noted above, in some cases, the server administrator at the server 102 is able to perform a preliminary investigation from data, without the ETL developer's help. For example, the server administrator at the server 102 can determine by examining data output to a destination the nature of a problem. Alternatively, preliminary reports may be generated which the server administrator can examine.

In many cases, the server administrator has an already completed/failed/success execution before the server administrator starts investigation on the data-related issues

Integration packages and processes may include data flows. Each data flow includes one or more data flow components. A data flow component can refer to a source, transformation or destination. FIG. 2 illustrates an example source component 202, transformation component 204 and destination component 206. A source component typically has at least two outputs, including at least one data output and one error output. However, embodiments may be implemented where the source component 202 only has a data output. The source component 202 in a data flow defines a source of data. For example, the source component may define a database or a flat file location from where data can be obtained.

A transformation component 204 typically has one or more inputs and one or more outputs. The transformation component defines how data from sources defined in source components 202 is handled and manipulated. For example, one merge transformation may support two inputs, namely, Input 1 and Input 2 where the two inputs are merged together into a single output. A merge/join transformation supports 2 inputs, namely, Left Input and Right Input to produce a single output. A multicast transformation can have 1 or more outputs that essentially reproduce the input of the multicast transformation to the outputs of the multicast transformation.

A destination component 206 has one or more inputs and typically has zero outputs. The destination component 206 defines where data that has been transformed by the data flow is stored. Example destination components may define databases where data is stored, flat file locations where data is stored, etc.

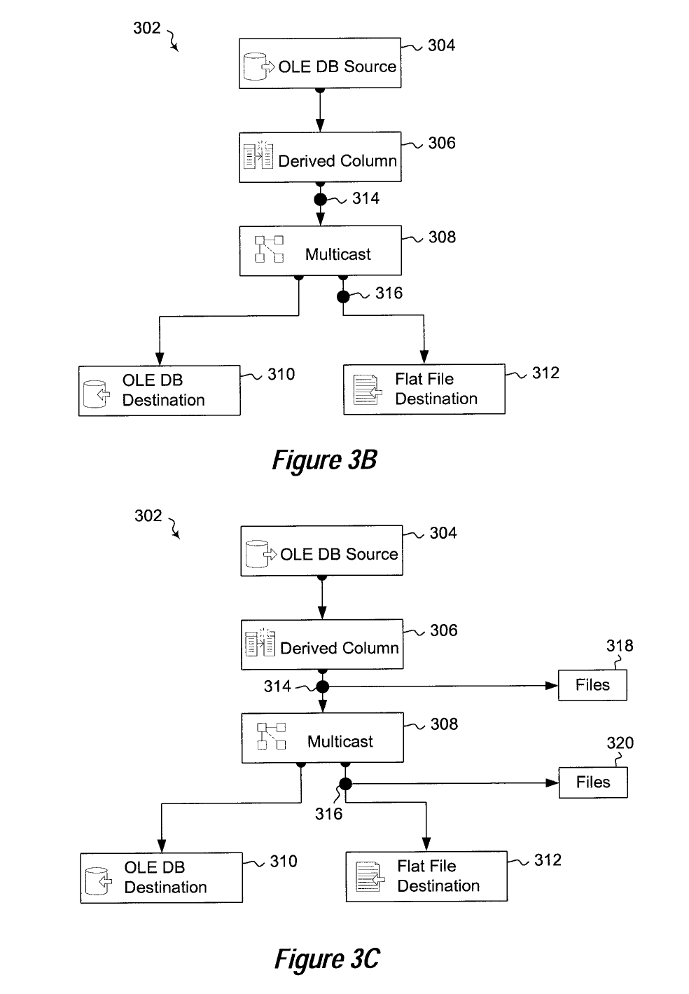

Reference is now made to FIGS. 3A-3C which illustrate an example of setting up and using a data tap. FIG. 3A illustrates a source component 304 of a data flow 302. FIG. 3A further illustrates two transformation components 306 and 308. FIG. 3A further illustrates two destination components 310 and 312. Given the data flow 302, the server administrator of a server, such as server 102 shown in FIG. 1, may wish to setup one or more data taps on specific points in the data flow 302 and direct the data from the taps to data files for investigation.

As shown in FIG. 3B, the server administrator can declaratively define the points of the data flow 302, shown as data taps 314 and 316, from which the data is to be tapped. As shown in FIG. 3C, when the data flow is executed, at runtime, the data that are passing through the data flow paths (with the data tap points) will also be written to files 318 and 320 respectively on disk. The file locations, in some embodiments may be default data dump directories that are created at setup time. Alternatively, the file locations may be specified by user input.

In some embodiments, to perform re-direction of data rows from a package, a server administrator: creates an execution, enables the execution for capturing data rows, and specifies certain information about the execution, such as the execution identifier, package name, data flow task name, component name, and the name of the output from which the administrator wants to capture data rows.

In some embodiments, the server administrator specifies a maximum cap on the number of rows that are captured. In some embodiments, by default, if no maximum is specified, a default may be implemented automatically. For example, a default of 1000 rows per component may be implemented.

Embodiments may be implemented where the server administrator cannot specify re-direction of data rows for executions that have already been started or completed executions. In some embodiments, if an execution is stopped mid-way in execution, a partial set of data rows may nonetheless be written to the files on disk.

Creating a tap may be implemented so as not to change the behavior of the package. For example, if the package already has error output being re-directed to some tables, that will continue to work.

Some embodiments may be implemented where the data rows that are captured are not logged into data stores that are the subject of transformation themselves. However in some embodiments, files with tapped data may be dumped to data store 104 in a data dumps directory. In some embodiments, these files may be secured by granting access only to specific users, such as a user who started the execution of the package, or an administrator of a machine.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

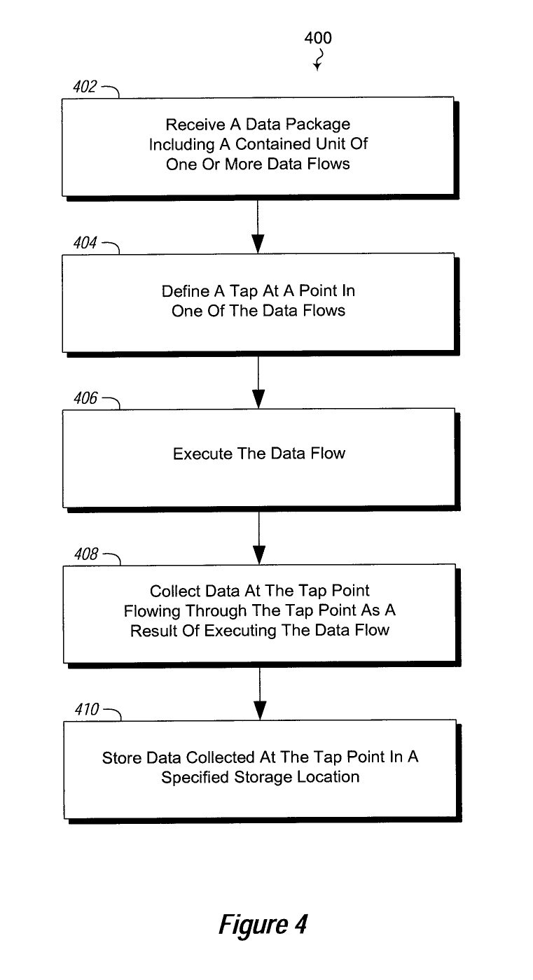

Referring now to FIG. 4, a method 400 is illustrated. The method 400 may be practiced in a computing environment. The method 400 includes acts for analyzing data in one or more data flows of an integration package. The integration package includes one or more executable integration processes including one or more data flows that when executed on a server cause data to be integrated from a source system to a destination system according to one or more transformations defined in the integration package.

The method 400 includes receiving a data package including a contained unit of one or more data flows (act 402). For example, FIG. 1 illustrates a data package 106 being received by the server 102. While the method 400 shows receiving a single data package, it should be appreciated that receiving a package could be performed as part of receiving a data integration project that contains one or more packages. Each of the packages describes a data integration process. Each of the packages may include one control flow, and several data flows. In a control flow, the package can invoke other packages. The data package 106 may have data flows therein, such as those illustrated in FIGS. 3A, 3B, and 3C. When executed, the data flows may cause data to be read from a source component, transformed according to some transformation components, and the transformed data stored to a destination defined by a destination component.

The method 400 further includes defining a tap at a point in one of the data flows (act 404). For example, as illustrated in FIG. 3C, data tap points 314 and 316 are defined. File locations 318 and 320 can be defined where tapped data should be stored. In some embodiments, the file location may be defined based on a data dump directory for a database server defined at start-up and is not changeable by a user. However, in other embodiments, the file locations 318 and 320 can be specified by user input.

The method 400 further includes executing the data flow (act 406). For example, the data flow 302 illustrated in FIGS. 3A, 3B, and 3C could be executed.

The method 400 further includes collecting data at the tap point flowing through the tap point as a result of executing the data flow (act 408). The method 400 further includes storing data collected at the tap point in the specified storage location (act 410). For example, executing the data flow 302 illustrated in FIG. 3C causes data to be transmitted past the taps 314 and 316. As data flows past the taps, the data can be collected and written to files 318 and 320 respectively.

The method 400 may further include generating preliminary high level trouble shooting data in a report. For example, as illustrated in FIG. 1, a high level report may be generated with troubleshooting data. As described previously, this high level report may be generated as a result of a server administrator specifically requesting that the report be generated, as the result of automatic report generations as part of a logging process, or for some other reason.

The preliminary high level trouble shooting data may be used to determine where the tap should be placed in the data flow. For example, a server administrator may be able to examine the high level trouble shooting data, and with the high level trouble shooting data determine a point in the data flow 302 where a tap should be placed. For example, the high level trouble shooting data may show what data was read from a source and what data was written to a destination. Alternatively or additionally, the high level trouble shooting data may show the number of rows that are read from a source, and the number of rows passed to a down-stream data flow component (which in some embodiments may be a destination). Examining this data may allow an administrator to determine that because of the discrepancy between read data from a source component and written data to a destination component, a tap should be placed before and/or after some transformation component.

In some embodiments, the method 400 may further include sending the preliminary high level trouble shooting data to a developer and receiving from the developer information indicating where the tap should be placed in the data flow. In particular, if a server administrator does not have sufficient information about data flows in an integration package, the server administrator may be able to send a preliminary report, such as the report 116 shown in FIG. 1, to a developer who created the integration package, or who better understands the integration package. The developer can then provide suggestions as to where taps should be placed in a data flow based on the preliminary report.

The method 400 may be practiced where defining a tap at a point in one of the data flows includes defining a tap filter for the data. For example, embodiments may be practiced where a server administrator can declaratively specify that only certain types, such as certain columns of data in a database, or other types of data are to be collected.

The method 400 may be practiced where defining a tap at a point in one of the data flows includes defining a maximum amount of data for the tap to collect. For example, a server administrator can declaratively specify how much data will be collected at a tap. In alternative embodiments, default maximums may be implemented. For example, in one embodiment, if not specified, a maximum of 1000 rows of data will be collected.

The method 400 may be practiced where storing data collected at the tap point in the specified storage location includes storing the data as a comma delimited file, such as a comma separated value (csv) file. In alternative embodiments, the data may be stored as an xml file, or some other file. Csv and xml files may be especially useful because data structure can be, at least partially, maintained. However, other file types can also facilitate maintaining structure, and other less structure maintaining file types can also be used when structure is of less importance.

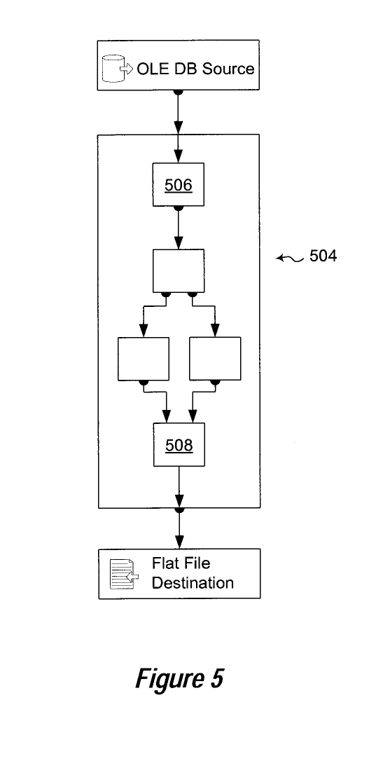

The method 400 may be practiced where defining a tap at a point in one of the data flows includes defining a tap to monitor data into or out of a child package. FIG. 5 illustrates an example where a transformation component 504 includes a number of child components. Generally, however, defining a tap will be performed by defining taps at the input of the transformation component 504, which is the input of child transformation component 506, or at the output of the transformation component 504, which is the output of the child transformation component 508.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of analyzing data in one or more data flows of one or more integration packages, the integration packages comprising one or more executable integration processes comprising one or more data flows that when executed on a server cause data to be integrated from a source system to a destination system according to one or more transformations defined in the integration packages, the method comprising:
receiving a data package comprising a contained unit of one or more data flows;
defining a tap at a point in one of the data flows;
executing the data flow;
collecting data at the tap point flowing through the tap point as a result of executing the data flow; and
storing data collected at the tap point in a specified storage location.

2. The method of claim 1, further comprising generating preliminary high level trouble shooting data in a report.

3. The method of claim 2, further comprising, using the preliminary high level trouble shooting data to determine where the tap should be placed in the data flow.

4. The method of claim 2, further comprising:
sending the preliminary high level trouble shooting data to a developer; and
receiving from the developer information indicating where the tap should be placed in the data flow.

5. The method of claim 1, wherein defining a tap at a point in one of the data flows comprises defining a tap filter for the data.

6. The method of claim 1, wherein defining a tap at a point in one of the data flows comprises defining a maximum amount of data for the tap to collect.

7. The method of claim 1, wherein storing data collected at the tap point in the specified storage location comprises storing the data as a comma delimited file.

8. The method of claim 1, wherein defining a tap at a point in one of the data flows comprises defining a tap to monitor data into or out of a child package.

9. In a computing environment, one or more computer readable media comprising computer executable instructions that when executed by one or more processors cause the following to be performed:
receiving a data package comprising a contained unit of one or more data flows;
defining a tap at a point in one of the data flows;
executing the data flow;
collecting data at the tap point flowing through the tap point as a result of executing the data flow; and
storing data collected at the tap point in a specified storage location.

10. The computer readable medium of claim 9, wherein the one or more computer readable media further comprise computer executable instructions that when executed by one or more processors cause generating preliminary high level trouble shooting data in a report.

11. The computer readable medium of claim 10, further wherein one or more computer readable media further comprise computer executable instructions that when executed by one or more processors cause using the preliminary high level trouble shooting data to determine where the tap should be placed in the data flow.

12. The computer readable medium of claim 10, wherein the one or more computer readable media further comprise computer executable instructions that when executed by one or more processors cause:
sending the preliminary high level trouble shooting data to a developer; and
receiving from the developer information indicating where the tap should be placed in the data flow.

13. The computer readable medium of claim 9, wherein defining a tap at a point in one of the data flows comprises defining a tap filter for the data.

14. The computer readable medium of claim 9, wherein defining a tap at a point in one of the data flows comprises defining a maximum amount of data for the tap to collect.

15. The computer readable medium of claim 9, wherein storing data collected at the tap point in the specified storage location comprises storing the data as a csv file.

16. The computer readable medium of claim 9, wherein defining a tap at a point in one of the data flows comprises defining a tap to monitor data into or out of a child package.

17. In a computing environment, a computing system for analyzing data in one or more data flows of one or more integration packages, the integration packages comprising one or more executable integration processes comprising one or more data flows that when executed on a server cause data to be integrated from a source system to a destination system according to one or more transformations defined in the integration packages, the system comprising:
one or more computer processors,
one or more computer readable media coupled to the one or more computer processors, the one or more computer readable media comprising computer executable instructions that when executed by one or more of the one or more processors cause the following to be performed:
receiving a data package comprising a contained unit of one or more data flows;
executing the data flows;
determining that errors have occurred when executing the data flows;
providing information about the errors to a developer;
receiving information from the developer about how and where to place a tap on a data flow in the one or more data flows;
defining a tap at a point in the data flow;
executing the data flow;
collecting data at the tap point flowing through the tap point as a result of executing the data flow; and
storing data collected at the tap point in a specified storage location.

18. The system of claim 17, wherein the computer readable media comprises computer executable instructions that when executed by one or more of the one or more processors cause a preliminary high level trouble shooting report to be generated based on predetermined tap locations.

19. The system of claim 18, wherein providing information about the errors to a developer comprises providing the preliminary report.

20. The system of claim 17, wherein defining a tap at a point in one of the data flows comprises defining a maximum amount of data for the tap to collect.
